(19) United States
(12) Patent Application Publication
(10) Pub. No.: US 2016/0366431 A1
(43) Pub. Date: Dec. 15, 2016

(54) VIDEO DECODING DEVICE AND VIDEO DECODING METHOD

(71) Applicant: FUJITSU LIMITED, Kawasaki-shi (JP)

(72) Inventor: Kimihiko KAZUI, Kawasaki (JP)

(73) Assignee: FUJITSU LIMITED, Kawasaki-shi (JP)

(21) Appl. No.: 15/099,213

(22) Filed: Apr. 14, 2016

(30) Foreign Application Priority Data
Jun. 15, 2015 (JP) 2015-120314

(51) Int. Cl. H04N 19/44; H04N 5/04

(52) U.S. Cl. CPC H04N 19/44; H04N 5/04

(57) ABSTRACT

A video decoding device includes: a decoder configured to decode pictures in each group of pictures; a calculator to calculate a generation time of a first vertical synchronization signal in a unit of a first cycle in which a first time interval between display times of consecutive pictures is not an integer multiple of the first cycle; a clock unit to synchronize a first oscillation cycle with the first cycle based on time synchronize information representing a time based on a first clock having the first cycle and to generate the first vertical synchronization signal; and a s generator to synchronize a second oscillation cycle such that an input interval of the first vertical synchronization signals coincides with a second time interval between display times of consecutive pictures represented as an integer multiple of a second cycle and to generate a second vertical synchronization signal and a horizontal synchronization signal.

### CROSS-REFERENCE TO RELATED APPLICATION

This application is based upon and claims the benefit from priority of the prior Japanese Patent Application No. 2015-120314, filed on Jun. 15, 2015, the entire contents of which are incorporated herein by reference.

### FIELD

The embodiments discussed herein are related to a video decoding device that decodes encoded video data and a video decoding method.

### BACKGROUND

Related technologies are disclosed in, for example, Japanese National Publication of International Patent Application No. 2005-505211.

Related technologies are disclosed in, for example, INTERNATIONAL STANDARD ISO/IEC 13818-1:ITU-T Recommendation H.222.0 “Information technology—Generic coding of moving pictures and associated audio information: Systems”, ISO/IEC FDIS 23008-1:2013(E) “Information technology—High efficiency coding and media delivery in heterogeneous environments—Part 1: MPEG media transport (MMT)”, and ARIB STD-B60 “MMT-BASED MEDIA TRANSPORT SCHEME IN DIGITAL BROADCASTING SYSTEMS”.

### SUMMARY

According to one aspect of the embodiments, a video decoding device includes: a decoder configured to decode encoded data of a plurality of pictures included in each group of pictures in an encoded stream from encoded data of each of the plurality of pictures; a vertical synchronization signal generation time calculator configured to calculate a generation time of a first vertical synchronization signal associated with each of the plurality of pictures in a unit of a first cycle in which a first time interval between display times of consecutive pictures among the plurality of pictures is not an integer multiple of the first cycle, based on first information on a number of pictures in the group of pictures and second information on display time of a leading picture in the group of pictures; a clock unit including a first oscillator with a first oscillation cycle and configured to synchronize the first oscillation cycle with the first cycle based on time synchronize information representing a time based on a first clock having the first cycle and to generate the first vertical synchronization signal for each of the pictures at the respective generation times based on a first synchronized oscillation cycle; and a synchronization signal generator including a second oscillator with a second oscillation cycle and configured to synchronize the second oscillation cycle such that an input interval of the first vertical synchronization signals coincides with a second time interval between display times of consecutive pictures among the plurality of pictures represented as an integer multiple of a second cycle and to generate a second vertical synchronization signal and a horizontal synchronization signal of each of the pictures based on a second synchronized oscillation cycle.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a configuration of a video decoding device according to an exemplary embodiment of the present disclosure;

FIG. 2 is a diagram illustrating a structure of an MMT stream;

FIG. 3 is a block diagram illustrating a configuration of a system clock unit;

FIG. 4 is a block diagram illustrating a configuration of an image synchronization signal generator; and

FIG. 5 is a flowchart illustrating an operation of a video decoding processing.

### DESCRIPTION OF EMBODIMENTS

As for the standard for multiplexing multiple media including video, audio or text, there are known the Moving Picture Experts Group phase 2 (MPEG-2) Systems (ISO/IEC 13818-1) and the MPEG Media Transport (MMT, ISO/IEC 23008-1) specified by the International Standardization Organization/International Electrotechnical Commission (ISO/IEC). In the digital television broadcasting, the transport stream (TS) format according to the MPEG-2 Systems standard (hereinafter referred to as “MPEG-2 TS”) is widely employed. In the next generation digital television broadcasting, the MMT is also to be employed.

One of the key functions of the media multiplexing is a synchronous reproduction of media contents in a video decoding device at a receiving end. For example, media contents are compressed and encoded, such that the resulting bit stream is multiplexed. In doing so, the compression ratio differs from picture to picture in video data or from audio frame to audio frame in audio data. Therefore, the time interval between arrivals of encoded data of a plurality of consecutive pictures included in a multiplexed bit stream at the video decoding device and the time interval between arrivals of encoded data of a plurality of consecutive audio frames at the video decoding device vary depending on the compression ratio. In order to accurately synchronize the reproduction time of video data and that of the audio data even in such a situation, a system clock is set as the reference for the reproduction time. For example, the reproduction time based on the system clock is added to the encoded data of each picture and the encoded data of each audio frame.

The system clock is provided in each of the video encoding device at the transmitting end and the video decoding device at the receiving end. In addition, the system clock in the video encoding device may be required to be synchronized with the system clock in the video decoding device with a high resolution. When there is an error between the frequency of the system clock in the video encoding device and the frequency of the system clock in the video decoding device, the number of input pictures (frames) per unit time and the number of display pictures (frames) per unit time become different. Hence, the encoded data of pictures or the encoded data of audio frames do not arrive at the video decoding device by the timing for decoding. Or, a large volume of encoded data of pictures or encoded data of audio frames waiting for decoding are accumulated in the buffer of the video decoding device, so that buffer may overflow. As a result, there may be a dropping or an overlapping of video data or audio data in reproduction.

It is not desired to cause a dropping or an overlapping of, for example, display pictures in a video decoding device. Accordingly, the system clock included in the video decoding device and the system clock included in the video encoding device at the transmitting end may be required to be completely synchronized with a clock specifying a display cycle associated with pictures or the like input to the video encoding device. In the following description, the clock specifying a frame rate that is reciprocal of a display cycle of pictures, for example, the reproduction time interval between consecutive pictures (hereinafter, referred to as “one frame time”) is referred to as an “image signal clock.”

For example, the frequency of the system clock of the video encoding device is synchronized with the frequency of the image signal clock of the video data input thereto, and the counter value of the system clock is periodically delivered to the video decoding device. Accordingly, in addition to the synchronization between the system clock of the video encoding device and the system clock of the video decoding device, the frame rate of the decoded video data output from the video decoding device is also synchronized with the frame rate of the video data input to the video encoding device. Accordingly, the number of pictures input to the video encoding device per time completely coincides with the number of pictures displayed in the decoding device per time. As a result, even after the coded video data are transmitted over a long period of time, the entire pictures of the video data input to the video encoding device may be displayed at the video decoding device without dropping or repetition.

The video encoding device synchronizes the frequency of the system clock of the video encoding device with the frequency of the image signal clock of the input video data, for example, by using the phase locked loop (PLL). The video decoding device synchronizes the frequency of the system clock of the video decoding device and the clock counter value with the frequency of the system clock of the video encoding device and the clock counter value by using a program clock reference (PCR) packet according to the MPEG-2 standard. The display timing of each picture of the reproduced video data is determined depending on the system clock of the video decoding device.

In Japan or the United States, the frame rate is 30,000/1,001=29.97 Hz (in case of an interlaced type) or 60,000/1,001=59.94 Hz (in case of a progressive type). According to MPEG-2, the frequency of the system clock is specified as 27 MHz in order to accurately represent frame rates. In case of the interlaced type, one frame time (1/29.97 seconds) becomes 450,450 clocks in a 27 MHz clock. As such, one frame time becomes an integer multiple of the system clock cycle.

The frame rate associated with video data input to the video encoding device is not exactly a value obtained by dividing 27 MHz by an integer, allowing for variations within a specific range. For the television broadcasting, each broadcasting station distributes unified image signal clocks, and all devices in the broadcasting station is in synchronization. However, image signal clocks include different errors depending on broadcasting stations. Accordingly, a PCR packet is not common for the programs but is added to each of the programs.

In the meantime, MMT is different from MPEG-2 TS in that the former does not define a scheme in which the system clock of the device at the transmitting end is synchronized with the system clock of the device at the receiving end. Instead, MMT relies on regulations of individual application. The Japanese digital TV broadcast multiplexing standard (ARIB STD-B60) based on the MMT employs the system clock synchronization scheme based on the Coordinated Universal Time (UTC).

For example, each of the video encoding device at the transmitting end and the video decoding device at the receiving end has a system clock in synchronization with the UTC. The device at the transmitting end synchronizes its system clock with a time server by using a time synchronization protocol such as, for example, the Network Time Protocol (NTP, RFC 5905) or the Resolution Time Protocol (PTP, IEEE 1588). The device at the transmitting end periodically transmits its system clock value (UTC time) to device at the receiving end in the form of an NTP packet (hereinafter, data in the form of an NTP packet containing a system clock value is referred to as an “NTP packet”). The device at the receiving end synchronizes its system clock with the received UTC time by using the phase locked loop (PLL). Accordingly, the system clock of the device at the transmitting end is synchronized with the system clock of the device at the receiving end. As a result, in principle, the system clocks of all devices at the transmitting end and at the receiving end are synchronized with one another based on the UTC.

However, the system clock in synchronization with the UTC sometimes may not be completely synchronized with the image signal clock.

This is because a time in the UTC is represented with precision of 32-bit for one or more seconds and 32-bit for less than one second, while the frequency of the image signal clock is based on 27 MHz, such that a time in unit of 27 MHz may not be exactly represented by a time that can be represented in the UTC.

More Specifically, the frequency of a system clock in synchronization with the UTC is 2 to a power of n, e.g., 2²⁴=16,777,216 Hz. In contrast, the image signal clock is represented in the unit of 27 MHz. When the frame rate in video data is 60,000/1,001=59.94 Hz, one frame time (1,001/60,000=0.1668333 seconds) is represented as 450,450 cycles of the image signal clocks with the frequency of 27 MHz. In contrast, in the system clock in synchronization with the UTC, when the frequency is, for example, 2²⁴ Hz, one frame time becomes 279,899.8869333 cycles, so that the cycle number becomes a non-integer. However, the time that can be represented by the system clock in synchronization with the UTC may be limited to a time having an integer cycle number. Accordingly, when the above cycle number corresponding to one frame time is rounded off to the nearest integer, the cycle number becomes 279,899, which corresponds to 0.1668328 second. As a result, the error corresponding to one frame time takes place once in approximately 315,000 frames (87 minutes). This error varies depending on the exponent N that determines the frequency of the system clock. As N becomes smaller, the error becomes larger.

Further, the frequency of the image signal clock associated with video data input to the video encoding device at the transmitting end, e.g., a video encoding device, in a broadcasting station is not exactly 27 MHz but may include an error depending on broadcasting stations. For example, one flame time corresponds to a value obtained by adding an error 279,899.8869333 cycles. For example, when the frequency of the image signal clock in the video coding device is 27,000.200 Hz, the error may be approximately 2 cycles. As such, there are sometimes the cases where the image signal clock may not be represented accurately by using the system clock based on the UTC.

According to the standard described above, a synchronous decoding model of video data is based on the image signal clock, and the time at which each coded picture arrives at the video decoding device, decoding time, and display time are strictly specified. That is, on the assumption that the video decoding device includes the image signal clock that is identical to that of the video encoding device, the video encoding device controls a coding rate taking into account the time at which each coded picture arrives at the video decoding device, decoding time, and display time. Accordingly, when the image signal clock of the video decoding device is different from the image signal clock of the video encoding device, the decoding time and display time of each picture in the video decoding device deviate from the decoding time and the display time intended by the video encoding device. The deviation becomes larger in proportion to operation time. As a result, after the video decoding device operates for a long time, pictures are overlapped (e.g., a previously displayed picture is repeated) since encoded data of pictures does not arrive at the device until the deviated decoding time. Or, pictures are dropped due to an overflow of buffer of the video decoding device as the decoding time is delayed from the intended decoding time.

When the relationship between the image signal clock used by the video decoding device and the system clock based on the UTC is constant, it is possible for the video decoding device to compensate for the deviation in the decoding time and the display time of pictures by performing a scaling processing. As described above, however, this approach may not be applied since the image signal clocks include different errors depending on broadcasting stations.

One aspect of the present disclosure provides a video decoding device capable of suppressing dropping or overlapping of pictures even when a reference frequency of a system clock and a reference frequency of an image signal clock are different with each other.

Hereinafter, a video decoding device will be described with reference to the accompanying drawings. According to the MMT standard, a display time of MPU is described in the MPU header, which is assigned to each MPU (media processing unit) that corresponds to a unit including a plurality of access units (AU), based on the UTC time. For video data, an MPU is a group of pictures (GOP) corresponding to a group of pictures in which the encoding mode and the encoding order of each picture are specified. That is, in each MPU header, the display time of the leading picture of a GOP corresponding to the MPU header is described based on the UTC time.

An error between the display time pts of the leading picture of a GOP described in the MPU header and a generation time of the vertical synchronization signal of the picture lies within ±Δ, where Δ is the reciprocal of the frequency of a system clock. Accordingly, a signal generated at the time pts has the frequency of F/M and the jitter of A, such that the signal is stable. In addition, F denotes a frame rate, and M denotes the number of pictures within a GOP.

Accordingly, the video decoding device has a clock whose frequency is 27 MHz (hereinafter, referred to as “27 MHz clock”) as well as the system clock whose frequency is 2^{N} Hz in synchronization with the UTC. The video decoding device synchronizes its clock so that the input interval between the vertical synchronization signals of the pictures determined in the UTC reference coincides with one frame time by the 27 MHz clock. Accordingly, the video decoding device allows the pictures that are encoded video data to be decoded to be reproduced at a frame rate specified by the 27 MHz clock. Herein, the pictures included in video data may be either frames used in the progressive type or fields used in the interlaced type.

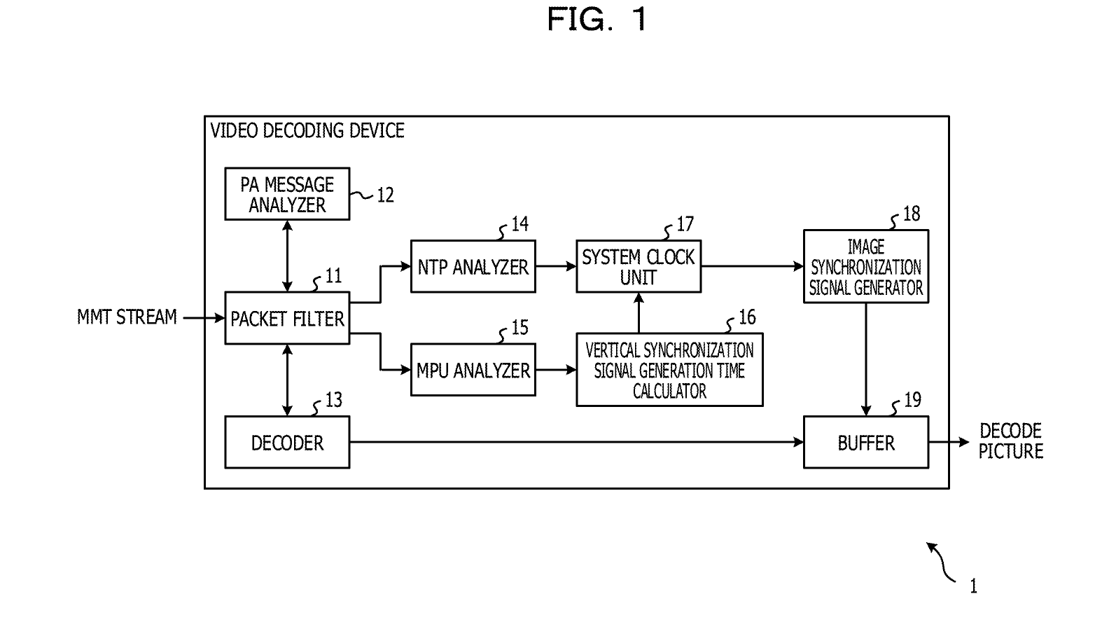

FIG. 1 is a block diagram illustrating a configuration of a video decoding device according to an exemplary embodiment. The video decoding device 1 includes a packet filter 11, a PA message analyzer 12, a decoder 13, an NTP analyzer 14, an MPU analyzer 15, a vertical synchronization signal generation time calculator 16, a system clock unit 17, an image synchronization signal generator 18, and a buffer 19. The elements included in the video decoding device 1 may be implemented in the video decoding device 1 as separate circuits. Alternatively, the elements included in the video decoding device 1 may be implemented in the video decoding device 1 as one or more integrated circuits that perform the functions of the respective elements.

The packet filter 11 analyzes, according to the MMT standard, a bit stream which is received from a video encoding device having a system clock based on the UTC and includes encoded data of each of multiple media contents coded and multiplexed according to the MMT standard. In addition, the packet filter 11 extracts various types of messages, packets and so on from the bit stream. In the following description, the bit stream that includes encoded data of each of multiple media contents multiplexed according to the MMT standard is referred to as an “MMT stream.”

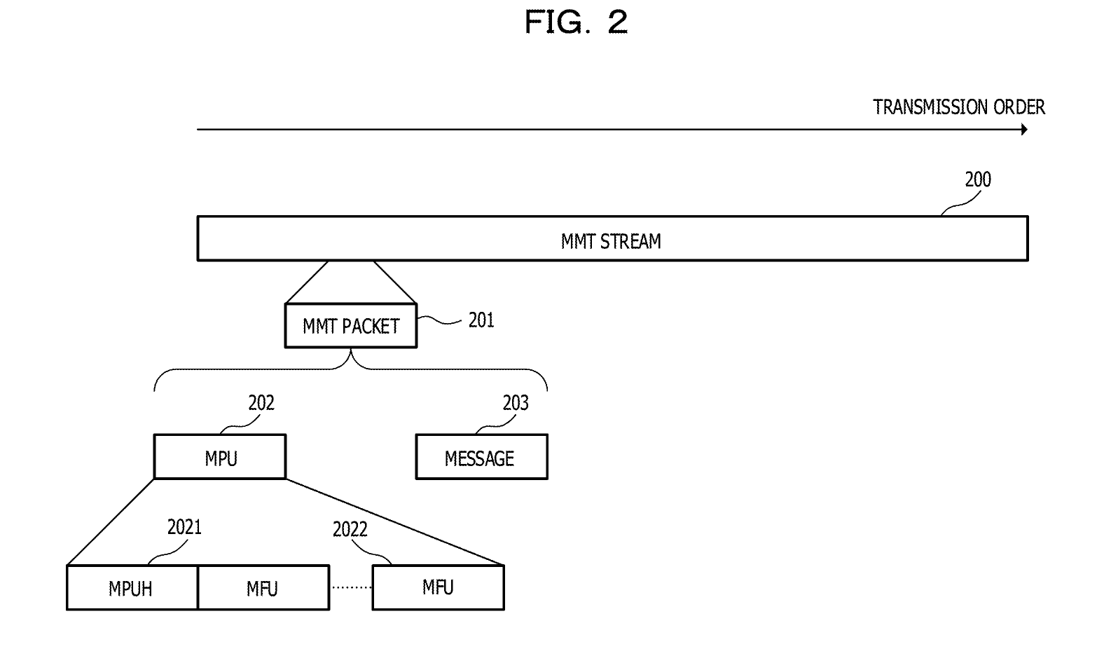

FIG. 2 is a diagram illustrating a structure of an MMT stream. An MMT stream 200 is generated by, for example, a video encoding device and includes a number of MMT packets 201. The MMT packets 201 may be classified as an MPU packet 202 storing encoded data of media or a message packet 203 storing various types of control data. The MPU packet 202 includes an MPU header 2021 and a plurality of media fragment units (MFUs) 2022. The display time of the MPU is described in the MPU header 2021. The types of the message packet 203 include, for example, an NTP packet, a packet access (PA) message, an MPU time stamp descriptor.

In this exemplary embodiment, the packet filter 11 extracts from the MMT stream the PA message, the NTP packet, the MPU packet, and the MPU time stamp descriptor. In addition, the packet filter 11 delivers the PA message to the PA message analyzer 12, and the NTP packet to the NTP analyzer 14. In addition, the packet filter 11 delivers the MPU header of the MPU packets corresponding to the ID specified by the PA message analyzer 12 to the MPU analyzer 15, and delivers information other than the MPU header to the decoder 13. Further, the packet filter 11 delivers the MPU time stamp descriptor to the MPU analyzer 15. In addition, the packet filter 11 may deliver a packet containing encoded data of media other than video data to a media decoder (not illustrated) that decodes the encoded data of the media. The media decoder may decode the media based on the decoding time determined based on the system clock.

The PA message analyzer 12 analyzes a PA message corresponding to a program map table (PMT) defined by MPEG-2 TS, and specifies the packet ID of the MPU packet for decoding the encoded video data. Then, the PA message analyzer 12 notifies the packet filter 11 of the specified ID. The PA message is specified by ARIB STD-B60.

The decoder 13 decodes each of pictures from the encoded data of the respective pictures included in MPU according to the encoding standard by which the video data has been coded. In addition, whenever a picture is decoded, the decoder 13 stores the picture in the buffer 19 together with the display order of the picture in the group of pictures. For example, the decoder 13 may determine the start timing of decoding each of the pictures based on a temporal relationship between the decoding order of the pictures or decoding time described in the MMT stream and the vertical synchronization signal of one picture output from the image synchronization signal generator 18.

The NTP analyzer 14 takes an NTP value representing a specific time by the system clock which is indicated by the UTC time reference contained in the NTP packet, and notifies the NTP value to the system clock unit 17.

The MPU analyzer 15 analyzes the MPU header and the MPU time stamp descriptor and notifies the vertical synchronization signal generation time calculator 16 of the display time of the leading display picture in the MPU, i.e., GOP which is indicated by in the UTC time reference and the number of pictures in the MPU. For example, the MPU analyzer 15 acquires a frame rate F of video data contained in the MPU header. The frame rate F is a value when the video data is synchronized with the frequency of 27 MHz, i.e., the value represented by the image signal clock with the frequency of 27 MHz (not the input frequency of the actual video data that is substantially difficult to obtain by the video encoding device at the transmitting end). The frame rate F is, for example, 29.97 Hz or 59.94 Hz.

In addition, the MPU analyzer 15 acquires a display time pts of the picture presented first in the MPU described in the MPU time stamp descriptor, and the number M of pictures in the MPU (i.e., the number of the pictures included in the GOP) described in the MPU header. The MPU analyzer 15 notifies the vertical synchronization signal generation time calculator 16 of the values of pts and M.

The vertical synchronization signal generation time calculator 16 calculates generation times tlist[i] of vertical synchronization signals specifying the display timing of the pictures in the MPU, and notifies the generation times tlist[i] to the system clock unit 17.

In this exemplary embodiment, the unit of the generation times of the vertical synchronization signals are a 2^{N} Hz clock based on the UTC (where N is an integer equal to or larger than 1, e.g., 24). As described above, the clock having the frequency of 2^{N} Hz may not be represented as an integer multiple (or an integer division) of an image signal clock having the frequency of 27 MHz. Accordingly, the value obtained by dividing one MPU time (the time of M pictures, 2^{N} Hz clock unit) by M is not an integer. Accordingly, a display time interval between two consecutive pictures in the display order, for example, one frame time (tlist[i+1]—tlist[i]) is not constant but varies depending on pictures. In order to minimize such variation and to operate the image synchronization signal generator 18 stably, the vertical synchronization signal generation time calculator 16 may limit the absolute variation value of (tlist[i+1]—tlist[i]) to 1 clock or less, for examples, one cycle or less of the system clock.

It is assumed that the display time stamp pts of an MPU to be decoded is ptsNow, and the display time stamp pts of a MPU which has been transmitted immediately before the MPU to be decoded is ptsPrev. It is assumed that the number of pictures of the two MPUs is M. In this case, the vertical synchronization signal generation time calculator 16 calculates tlist[i] as described below.

Initially, the vertical synchronization signal generation time calculator 16 sets tlist[0] to ptsNow. Subsequently, the vertical synchronization signal generation time calculator 16 calculates tGOP, tFrame, and m1 according to the following equations:

tGOP=ptsNow−ptsPrev

tFrame=floor(tGOP/M)

m1=mod(tGOP, M)

where floor( ) denotes a function that rounds off numbers after the decimal point, and mod(a,b) denotes a function that obtains a remainder after dividing variable a by variable b. When ptsPrev is not defined, that is, the MPU to be decoded is the leading MPU of the MMT stream, the vertical synchronization signal generation time calculator 16 sets tFrame to floor((1/F)*f), and m1=M.

The tFrame denotes a count number of the system clock (frequency f) corresponding to an interval between two consecutive vertical synchronization signals that are closest to one frame time and equal to or less than one frame time. The tGOP denotes a count number of the system clock (frequency f) corresponding to a time of M consecutive vertical synchronization signals that are generated for one MPU. The m1 denotes the number of pictures in one MPU that have the interval between two consecutive vertical synchronization signals of (tFrame+1). That is, the number of pictures in one MPU that have the interval between two consecutive vertical synchronization signals of (tFrame+1) is (M−m1).

The vertical synchronization signal generation time calculator 16 calculates, based on the values of tFrame and m1, generation times of vertical synchronization signals tlist[i], where i=[0, M−1], from the leading picture in the display order in the MPU, for example, as follows:

tlist[i]=tlist[0]+(i*(tFrame+1)) i≦m1

tlist[i]=tlist[m1]+((i−m1)*tFrame) i>m1

For example, when N=24, M=15 and F=60,000/1,001 Hz, the values f, tGOP, tFrame, m1 and tlist[i] are as follows:

f=16,777,216
tGOP=4,478,398
tFrame=279,899
m1=14
tlist[0]=ptsNow
tlist[1]=ptsNow+279,900
...
tlist[14]=ptsNow+279,900*14
tlist[15]=ptsNow+279,900*14+279,899*1

According to a modified embodiment, the vertical synchronization signal generation time calculator 16 may calculate tlist[i] such that pictures having the interval between the vertical synchronization signals of (tFrame+1) and pictures having the interval between the vertical synchronization signals of tFrame alternate with one another.

In addition, when the frequency of the image signal clock of the video encoding device is (60,000/1,001+α) due to a factor such as, for example, a change of an environment (e.g., a temperature), tGOP varies depending on α. Also in this case, tlist[i] is calculated according to the above-described method that restores the image signal clock with high resolution.

The system clock unit 17 loads the NTP value notified from the NTP analyzer 14 to a counter therein or inputs the NTP value to the PLL therein, thereby synchronizing the system clock of the video decoding device 1 with the system clock of the video encoding device. In addition, when one of the generation times tlist[i] of the vertical synchronization signals associated with each of the pictures in a GOP and received from the vertical synchronization signal generation time calculator 16 becomes equal to the counter value therein, the system clock unit 17 outputs the vertical synchronization signal based on the UTC to the image synchronization signal generator 18. The system clock unit 17 will be described in detail below.

The image synchronization signal generator 18 receives a vertical synchronization signal based on the UTC output from the system clock unit 17 for every picture. In addition, the image synchronization signal generator 18 uses the PLL therein to synchronize the frequency of the oscillator such that the input internal between the vertical synchronization signals coincides with one frame time referenced to the clock having the frequency of 27 MHz included in the image synchronization signal generator 18. In addition, the image synchronization signal generator 18 divides the frequency of pulse signals from the oscillator according to display start timing of every picture and display start timing of each line of the picture, thereby generating a vertical synchronization signal and a horizontal synchronization signal. In addition, the image synchronization signal generator 18 outputs the vertical synchronization signal and the horizontal synchronization signal to the buffer 19 for every picture. The image synchronization signal generator 18 will be described in detail later.

The buffer 19 outputs the decoded pictures stored in the buffer 19 from an earlier one to a later one in display order whenever it receives a vertical synchronization signal from the image synchronization signal generator 18. At that time, the buffer 19 outputs a designated pixel value among the output pictures to the outside in synchronization with the horizontal synchronization signal received from the image synchronization signal generator 18. Then, the video decoding device 1 displays the picture on a display device (not illustrated) coupled to the video decoding device 1.

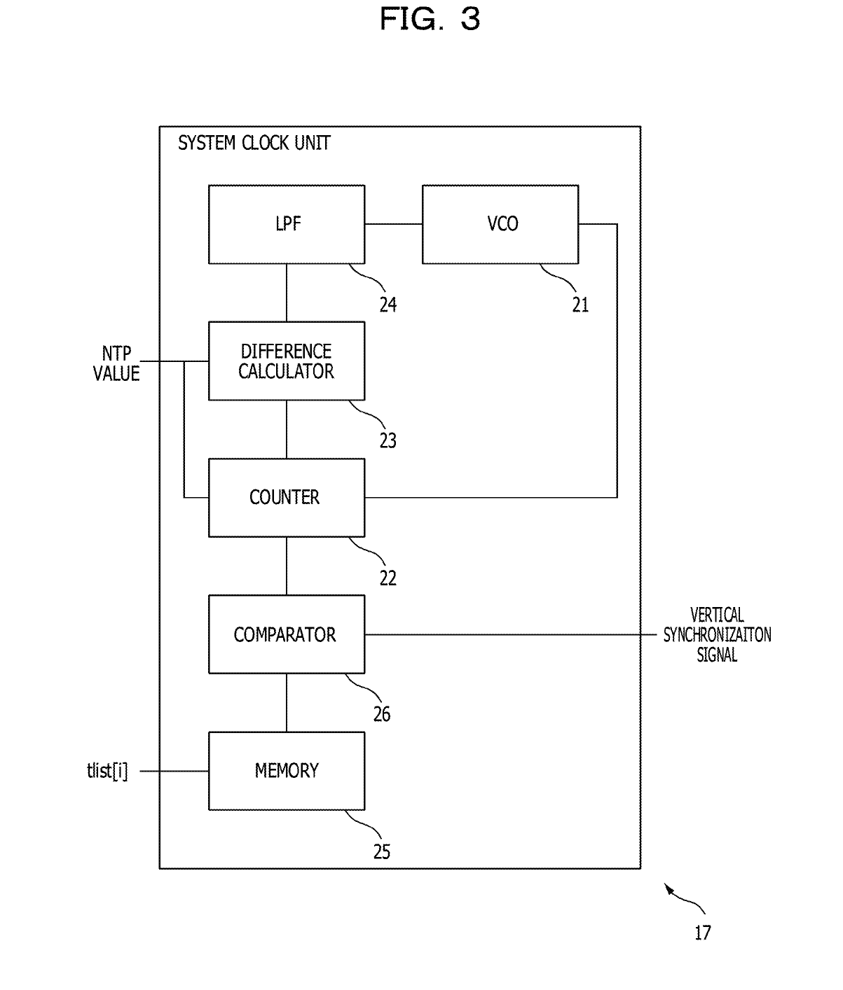

Hereinafter, the system clock unit 17 will be described in detail. FIG. 3 is a block diagram illustrating a configuration of the system clock unit 17. The system clock unit 17 includes a voltage-controlled oscillator (VCO) 21, a counter 22, a difference calculator 23, a low pass filter (LPF) 24, a memory 25, and a comparator 26. The elements of the system clock unit 17 may be incorporated as separate circuits or as one or more integrated circuits that perform the functions of the elements. The VCO 21, the counter 22, the difference calculator 23, and the LPF 24 form a PLL.

The VCO 21 is an example of a variable-frequency oscillator and is synchronized with the system clock of the video encoding device to generate a sinusoidal pulse signal when the frequency f is 2^{N} Hz. The pulse signal corresponds to the system clock of the video decoding device 1. The frequency f varies depending on the voltage value applied from the LPF 24. For example, the VCO 21 increases the frequency f as the voltage value applied becomes higher. The pulse signal output from the VCO 21 is input to the counter 22.

Immediately after an MMT stream is received, for example, at the initialization time such as start of video decoding, the counter 22 loads an input NTP value and keeps the value as an initial count value. At times other than the initialization time, the counter 22 increases the kept count value by one whenever a pulse signal having the frequency f is input from the VCO 21, for example, a sinusoidal wave of one cycle is input. The counter 22 outputs the count value to the difference calculator 23 and the comparator 26 whenever the count value is updated.

The difference calculator 23 calculates a difference between the count value output from the counter 22 and the received NTP value. Then, the difference calculator 23 outputs the difference value to the LPF 24. When the system clock of the system clock unit 17 is in synchronization with the system clock of the video encoding device based on the UTC, the difference value is zero.

The LPF 24 applies a low pass filter regarding a time change in the difference value received from the difference calculator 23 on the difference value to smooth the time change in the difference value and calculates a voltage value corresponding to the smoothed difference value. Then, the LPF 24 outputs the voltage value to the VCO 21. As described above, when the frequency f of the pulse signal output from the VCO 21 increases as the voltage value applied to the VCO 21 becomes higher, the LPF 24 increases the voltage value as the NPT value becomes larger than the count value. In the meantime, the LPF 24 decreases the voltage value as the NPT value becomes smaller than the count value. Accordingly, the system clock unit 17 may cause the system clock of the system clock unit 17 to follow the NPT value of each of the MPUs included in the MMT stream. Accordingly, the system clock unit 17 may synchronize the system clock of the video encoding device with the system clock of the video decoding device 1.

The memory 25 includes as many registers as the number M of pictures included in the MPU, i.e., GOP and stores generation times tlist[i] of the vertical synchronization signals of each of the pictures in the GOP input from the image synchronization signal generator 18, where i=0, 1, . . . , M−1. The generation times tlist[i] of the vertical synchronization signals stored in the memory 25 are read out by the comparator 26.

The comparator 26 outputs a vertical synchronization signal in the form of pulse when the count value output from the counter 22 coincides with one of generation times tlist[i] of M vertical synchronization signals stored in the memory 25.

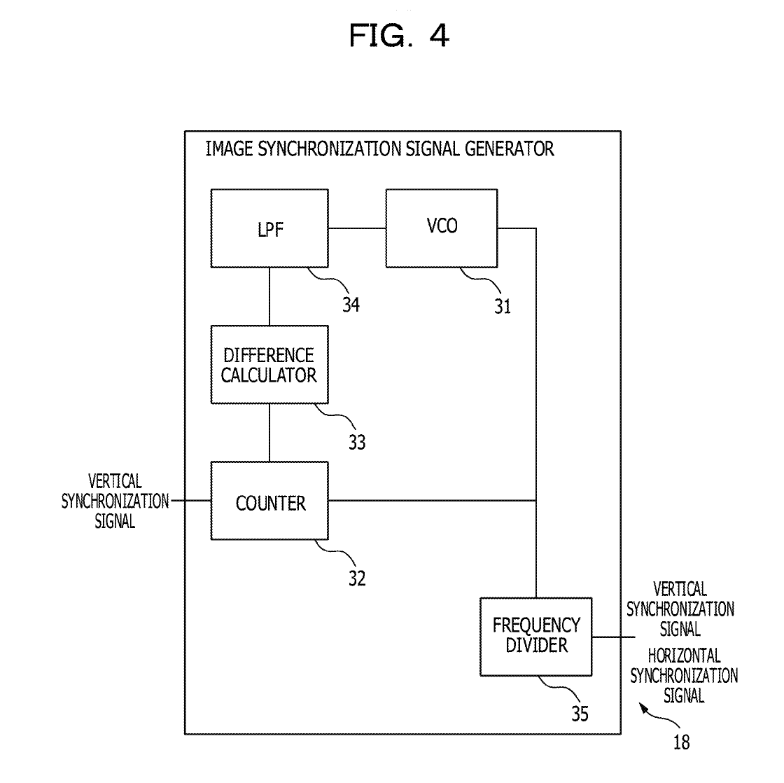

Hereinafter, the image synchronization signal generator 18 will be described in detail. FIG. 4 is a block diagram illustrating a configuration of the image synchronization signal generator 18. The image synchronization signal generator 18 includes a voltage-controlled oscillator (VCO) 31, a counter 32, a difference calculator 33, a low pass filter (LPF) 34, and a frequency divider 35. The elements of the image synchronization signal generator 18 may be incorporated as separate circuits or as one or more integrated circuits that perform the functions of the elements. The VCO 31, the counter 32, the difference calculator 33, and the LPF 34 form the PLL.

The VCO 31 is an example of a variable-frequency oscillator and matches the input interval between the vertical synchronization signals based on the UTC with one frame time by the image signal clock with a frequency of 27 MHz to thereby generate a specific number of sinusoidal pulse signals corresponding to a frame rate within one frame time. The pulse signal corresponds to a clock signal with the frequency of 27 MHz. The frequency f varies depending on the voltage value applied from the LPF 34. For example, the VCO 31 increases the frequency f the applied voltage value becomes higher. The pulse signal output from the VCO 31 is input to the counter 32.

The counter 32 outputs the count value to the difference calculator 33 at the rising edge of the pulse of the vertical synchronization signal. Then, the counter 21 resets the counter value to zero after outputting the count value. In addition, the counter 32 increases the count value by one when the sinusoidal wave rises whenever a pulse signal of the frequency f from the VCO 31 is input, i.e., whenever a sinusoidal wave of one cycle is input.

The difference calculator 33 calculates a difference value between the count value received from the counter 32 and a specific fixed value. The fixed value is, for example, the number of pulse signals with the frequency of 27 MHz corresponding to one frame time. For example, when the frame rate is 60,000/1,001 Hz (59.94 Hz), the fixed value is 450,450. Then, the difference calculator 33 outputs the difference value to the LPF 34.

The LPF 34 applies a low pass filter regarding a time change in the difference value received from the difference calculator 33 on the difference value to smooth the time change in the difference value and calculates a voltage value corresponding to the smoothed difference value. Then, the LPF 34 outputs the voltage value to the VCO 31. When the frequency f of the pulse signal output from the VCO 31 increases as the voltage value applied to the VCO 31 becomes higher, the LPF 34 increases the voltage value as the fixed value becomes larger than the count value. In the meantime, the LPF 34 decreases the voltage value as the fixed value becomes smaller than the count value. As a result, the image synchronization signal generator 18 may match the input intervals of the vertical synchronization signals with one frame time by the 27 MHz clock.

The frequency divider 35 divides the frequency of a clock signal with the frequency of 27 MHz output from the VCO 31 according to a specific frequency division ratio and outputs a vertical synchronization signal and a horizontal synchronization signal of each of the pictures. The frequency division ratio associated with the vertical synchronization signal is set based on, for example, one frame time. The frequency division ratio associated with the horizontal synchronization signal is set based on, for example, one frame time and the number of pixels in the vertical direction per picture.

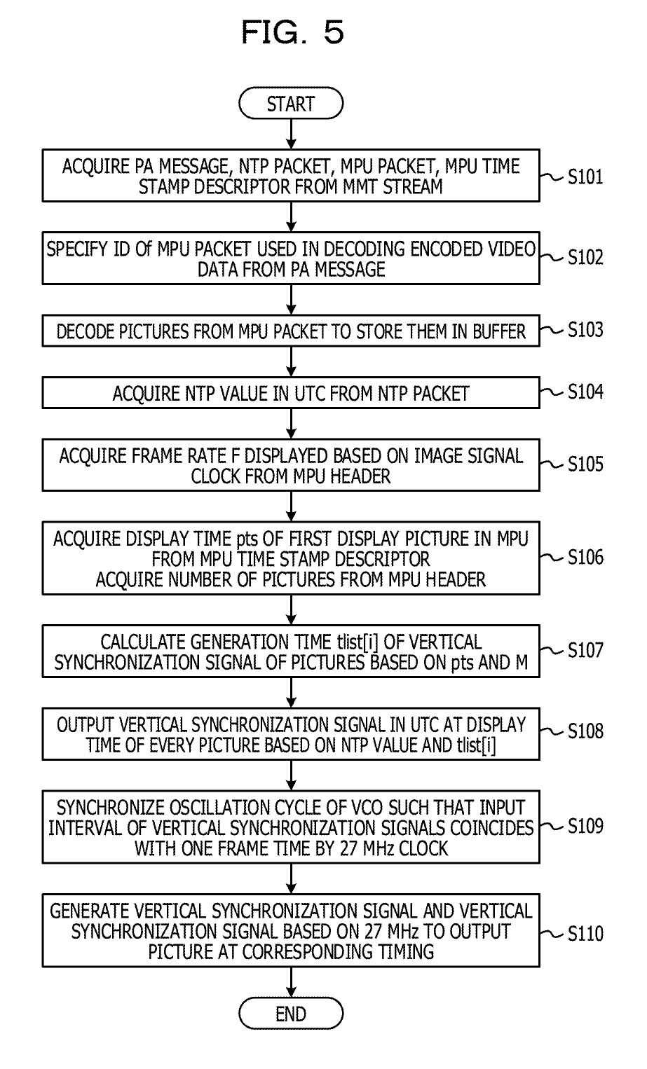

FIG. 5 is a flowchart illustrating an operation of the video decoding processing performed by the video decoding device 1. The video decoding device 1 decodes each of pictures in every MPU according to the following flowchart of the operation.

The packet filter 11 extracts from a received MMT stream a PA message, an NTP packet, an MPU packet, and an MPU time stamp descriptor (operation S101). The PA message analyzer 12 analyzes the PA message and specifies the packet ID of the MPU packet for decoding of encoded video data (operation S102).

The decoder 13 decodes each of encoded pictures in an MPU according to the encoding standard by which the video data has been coded. In addition, whenever a picture is decoded, the decoder 13 stores the picture in the buffer 19 (operation S103).

The NTP analyzer 14 takes an NTP value representing a specific time by the system clock based on the UTC time contained in the NTP packet, and notifies the system clock unit 17 of the NTP value (operation S104).

The MPU analyzer 15 acquires a frame rate F of video data represented by the image signal clock with the frequency of 27 MHz from the MPU header (operation S105). In addition, the MPU analyzer 15 acquires a display time stamp pts of the picture presented first in the MPU from the MPU time stamp descriptor, and the number M of pictures in the MPU from the MPU header (operation S106).

The vertical synchronization signal generation time calculator 16 calculates generation times tlist[i] of vertical synchronization signals associated with each of the pictures in the MPU based on the values of pts and M, and notifies the system clock unit 17 of the generation times tlist[i] (operation S107).

The system clock unit 17 outputs a vertical synchronization signal based on the UTC at the display time of each of the pictures in the MPU based on the NTP value and the generation times tlist[i] (operation S108).

The image synchronization signal generator 18 synchronizes the oscillation frequency of a VOC 31 such that the input intervals of the vertical synchronization signals based on the UTC matches one frame time by the 27 MHz clock (operation S109). The image synchronization signal generator 18 divides the frequency of the clock to generate a vertical synchronization signal and a horizontal synchronization signal based on 27 MHz. In addition, the image synchronization signal generator 18 outputs a corresponding picture from the buffer 19 according to the timing of a vertical synchronization signal and a horizontal synchronization signal, and displays the picture on a display device (not illustrated) coupled to the video decoding device 1 (operation S110). Then, the video decoding device 1 ends the video decoding processing.

As described above, the video decoding device includes the oscillator that generates clock signals based on the frequency of 27 MHz for accurately reproducing one frame time, as well as the oscillator that generates the system clock based on the UTC. In addition, the video decoding device synchronizes the clock for image signals with a vertical synchronization signal of each picture generated based on the system clock based on the UTC, and controls the display of respective pictures based on the clock for image signals. Accordingly, the video decoding device may suppress dropping or overlapping of pictures since the display time of each of the picture may be reproduced accurately according to the frame rate even if the system clock is based on the UTC.

The exemplary embodiment of the present disclosure is not limited to the MMT standard but may be applied to a variety of video decoding devices operating according to a system clock in which one frame time is not an integer multiple of the system clock.

The video decoding device according to the exemplary embodiment or the modification may find various applications. For example, the video decoding device may be inserted in a video camera, an image reception device, a television phone system, a computer or a mobile phone.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A video decoding device comprising:
a decoder configured to decode encoded data of a plurality of pictures included in each group of pictures in an encoded stream from encoded data of each of the plurality of pictures;
a vertical synchronization signal generation time calculator configured to calculate a generation time of a first vertical synchronization signal associated with each of the plurality of pictures in a unit of a first cycle in which a first time interval between display times of consecutive pictures among the plurality of pictures is not an integer multiple of the first cycle, based on first information on a number of pictures in the group of pictures and second information on display time of a leading picture in the group of pictures;
a clock unit including a first oscillator with a first oscillation cycle and configured to synchronize the first oscillation cycle with the first cycle based on time synchronize information representing a time based on a first clock having the first cycle and to generate the first vertical synchronization signal for each of the pictures at the respective generation times based on a first synchronized oscillation cycle; and
a synchronization signal generator including a second oscillator with a second oscillation cycle and configured to synchronize the second oscillation cycle such that an input interval of the first vertical synchronization signals coincides with a second time interval between display times of consecutive pictures among the plurality of pictures represented as an integer multiple of a second cycle and to generate a second vertical synchronization signal and a horizontal synchronization signal of each of the pictures based on a second synchronized oscillation cycle.

2. The video decoding device according to claim 1, further comprising:
a buffer storing decoded pictures therein and configured to output one of the decoded pictures based on the second vertical synchronization signal and the second horizontal synchronization signal.

3. The video decoding device according to claim 1, wherein the vertical synchronization signal generation time calculator calculates the generation time of the first vertical synchronization signal such that a difference in intervals between the generation times of the first vertical synchronization signals of two consecutive pictures among the plurality of pictures included in the group of pictures is equal to or less than the first cycle.

4. The video decoding device according to claim 1, wherein the first clock corresponds to a system clock and a second clock having the second cycle corresponds to an image signal clock of the encoded stream.

5. The video decoding device according to claim 1, wherein the first clock oscillator increases the first oscillation cycle as a voltage to be supplied to the first clock oscillator increases.

6. A video decoding method comprising:
decoding encoded data of a plurality of pictures included in each group of pictures in an encoded stream from encoded data of each of the plurality of pictures;
calculating a generation time of a first vertical synchronization signal associated with each of the pictures included in the plurality of pictures in a unit of a first cycle in which a first time interval between display times of consecutive pictures among the plurality of pictures is not an integer multiple of the first cycle, based on first information on a number of pictures in the plurality of pictures and second information on display time of a leading picture in the plurality of pictures;
synchronizing a first oscillation cycle of a first oscillator with the first cycle based on time synchronize information representing a time based on a first clock having the first cycle to generate the first vertical synchronization signal for each of the pictures at the respective generation times based on a first synchronized oscillation cycle; and
synchronizing a second oscillation cycle of a second oscillator such that an input interval of the first vertical synchronization signals coincides with a second time interval between display times of consecutive pictures among the plurality of pictures represented as an integer multiple of a second cycle and generating a second vertical synchronization signal and a horizontal synchronization signal of each of the pictures based on a second synchronized oscillation cycle.

7. The video decoding method according to claim 6, further comprising:
outputting one of the decoded pictures based on the second vertical synchronization signal and the second horizontal synchronization signal.

8. The video decoding method according to claim 6, wherein the generation time of the first vertical synchronization signal is calculated such that a difference in intervals between the generation times of the first vertical synchronization signals of two consecutive pictures among the plurality of pictures included in the group of pictures is equal to or less than the first cycle.

9. The video decoding method according to claim 6, wherein the first clock corresponds to a system clock and a second clock having the second cycle corresponds to an image signal clock of the encoded stream.

10. The video decoding method according to claim 6, wherein the first clock oscillator increases the first oscillation cycle as a voltage to be supplied to the first clock oscillator increases.
